(19) United States
(12) Patent Application Publication
(10) Pub. No.: US 2019/0293160 A1
(43) Pub. Date: Sep. 26, 2019

(54) DIFFERENTIAL

(71) Applicant: JTEKT CORPORATION, Osaka-shi (JP)

(72) Inventors: Yasunori Kamitani, Fujimi-shi (JP); Tadashi Yoshisaka, Kariya-shi (JP); Motoyasu Yamamori, Nagoya-shi (JP)

(73) Assignee: JTEKT CORPORATION, Osaka-shi (JP)

(21) Appl. No.: 16/358,000

(22) Filed: Mar. 19, 2019

(30) Foreign Application Priority Data
Mar. 20, 2018 (JP) 2018-53344

(51) Int. Cl. F16H 48/24; F16H 48/11; F16H 48/34; F16D 27/118; F16D 11/14

(52) U.S. Cl. CPC F16H 48/24; F16H 48/11; F16H 2048/346; F16D 27/118; F16D 11/14; F16H 48/34

(57) ABSTRACT

A differential includes first and second side gears, a differential case, a spacing member, and a clutch ring. First and second driving shafts are respectively coupled to the first and second side gears. The differential case houses the first and second side gears. The spacing member is inserted into the differential case through an insertion hole of the differential case. A head of the spacing member is disposed in an inter-shaft space between the first and second driving shafts so as to maintain a spacing of a predetermined distance or more between the first and second driving shafts. The clutch ring is axially movably disposed between the first side gear and the second side gear. The clutch ring meshes with the second side gear so as to restrict rotation of the second side gear relative to the differential case.

### INCORPORATION BY REFERENCE

The disclosure of Japanese Patent Application No. 2018-053344 filed on Mar. 20, 2018, including the specification, drawings and abstract, is incorporated herein by reference in its entirety.

### BACKGROUND OF THE INVENTION

### 1. Field of the Invention

The invention relates generally to differentials. More particularly, the invention relates to a differential that is able to differentially distribute a driving force from a driving source to a pair of driving shafts.

### 2. Description of the Related Art

A differential known in the related art may be able to differentially distribute a driving force from a driving source to a pair of driving shafts of a vehicle. Such a differential may have a “differential lock function” to limit differential rotations of the driving shafts. The applicants of the invention disclose a differential of this type in Japanese Patent Application Publication No. 2017-161063 (JP 2017-161063 A).

The differential disclosed in JP 2017-161063 A is a differential limiting device including a pair of side gears, a differential case, a plurality of pinion gear sets, an annular meshing member, and a mover. The side gears are disposed coaxially such that the side gears are rotatable relative to each other. The differential case is rotated by a driving force from a driving source. The pinion gear sets are able to transmit the driving force from the differential case to the side gears in such a manner as to allow differential rotations of the side gears. The meshing member is disposed such that the meshing member is axially movable and non-rotatable relative to the differential case. The meshing member serves as a connecting and disconnecting member that meshes with one of the side gears so as to restrict rotation of the one of the side gears relative to the differential case. The mover axially moves the meshing member. An end of each of right and left driving shafts is coupled to an associated one of the side gears such that the right and left driving shafts are each non-rotatable relative to the associated side gear. Each of the right and left driving shafts is a drive shaft to transmit the driving force to an associated one of right and left driving wheels.

The differential case includes a first case and a second case. The first case has a bottomed cylindrical shape. The second case closes an opening defined in the first case. The first case includes a cylindrical portion retaining the pinion gear sets, and a bottom extended inward from an end of the cylindrical portion. The meshing member is disposed between the bottom of the first case and the one of the side gears such that the bottom of the first case, the meshing member, and the one of the side gears are arranged axially side by side.

In some cases, vehicles equipped with differentials may require a spacer between driving shafts each coupled to an associated one of side gears. The spacer is disposed so as to maintain a spacing of a predetermined distance or more between the driving shafts. Disposing such a spacer in the differential disclosed in JP 2017-161063 A unfortunately increases the axial length of the differential case in accordance with the axial thickness of the spacer, resulting in an increase in the size of the differential. This may produce adverse effects, such as an increase in weight and difficulty in installing the differential on a vehicle.

### SUMMARY OF THE INVENTION

An object of the invention is to provide a differential that is able to limit differential rotations of a pair of side gears, includes a spacing member maintaining a spacing between driving shafts each coupled to an associated one of the side gears and is able to restrain an increase in size of the differential.

A differential according to an aspect of the invention includes a first driving shaft, a second driving shaft, a first side gear, a second side gear, a case, a plurality of pinion gears, a spacing member, a meshing member, and a mover. Rotation of the first side gear relative to the first driving shaft is restricted. Rotation of the second side gear relative to the second driving shaft is restricted. The second side gear is disposed coaxially with the first side gear. The case houses the first and second side gears. The case is rotated by a driving force from a driving source of a vehicle. The pinion gears revolve around a rotation axis of the case in conjunction with the rotation of the case and transmit the driving force from the case to the first and second side gears while allowing differential rotations of the first and second side gears. The spacing member is disposed into the case through an insertion hole of the case. The spacing member is partially disposed in an inter-shaft space between an axial end face of the first driving shaft and an axial end face of the second driving shaft so as to maintain a spacing of a predetermined distance or more between the first and second driving shafts. The meshing member is disposed such that the meshing member is movable relative to the case in an axial direction and non-rotatable relative to the case. The axial direction is parallel to the rotation axis. The meshing member meshes with the second side gear so as to restrict rotation of the second side gear relative to the case. The mover moves the meshing member in the axial direction between a first position where the meshing member is out of mesh with the second side gear and a second position where the meshing member is in mesh with the second side gear. The meshing member is disposed between the first side gear and the second side gear.

The differential according to the above aspect is able to limit differential rotations of a pair of side gears and includes a spacing member maintaining a spacing between driving shafts each coupled to an associated one of the side gears and is able to restrain an increase in size of the differential.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1A is an external view of a differential according to an embodiment of the invention, as viewed in the direction of a rotation axis of a differential case;

FIG. 1B is a cross-sectional view of the differential according to the embodiment of the invention, taken along the line A-A in FIG. 1A; FIG. 2A is an overall cross-sectional view of the differential taken along the line B-B in FIG. 1A;

FIG. 2B is a partially enlarged cross-sectional view of the differential taken along the line B-B in FIG. 1A;

FIG. 3 is an exploded perspective view of the differential;

FIG. 4 is an exploded perspective view of the differential at an angle different from that of FIG. 3;

FIG. 5A is a perspective view of a clutch ring;

FIG. 5B is a perspective view of the clutch ring at an angle different from that of FIG. 5A;

FIG. 5C is a diagram illustrating the clutch ring, as viewed in the direction indicated by the arrow C in FIG. 5A;

FIG. 5D is a diagram illustrating the clutch ring, as viewed in the direction indicated by the arrow D in FIG. 5B;

FIG. 6A is a perspective view of a tubular member;

FIG. 6B is a diagram illustrating the tubular member, as viewed in the direction indicated by the arrow E in FIG. 6A;

FIG. 7A is a schematic diagram illustrating the step of fitting a second retaining ring to a second driving shaft;

FIG. 7B is a plan view of the second retaining ring in a natural state; and

FIG. 7C is a plan view of the second retaining ring increased in diameter.

### DETAILED DESCRIPTION OF EMBODIMENTS

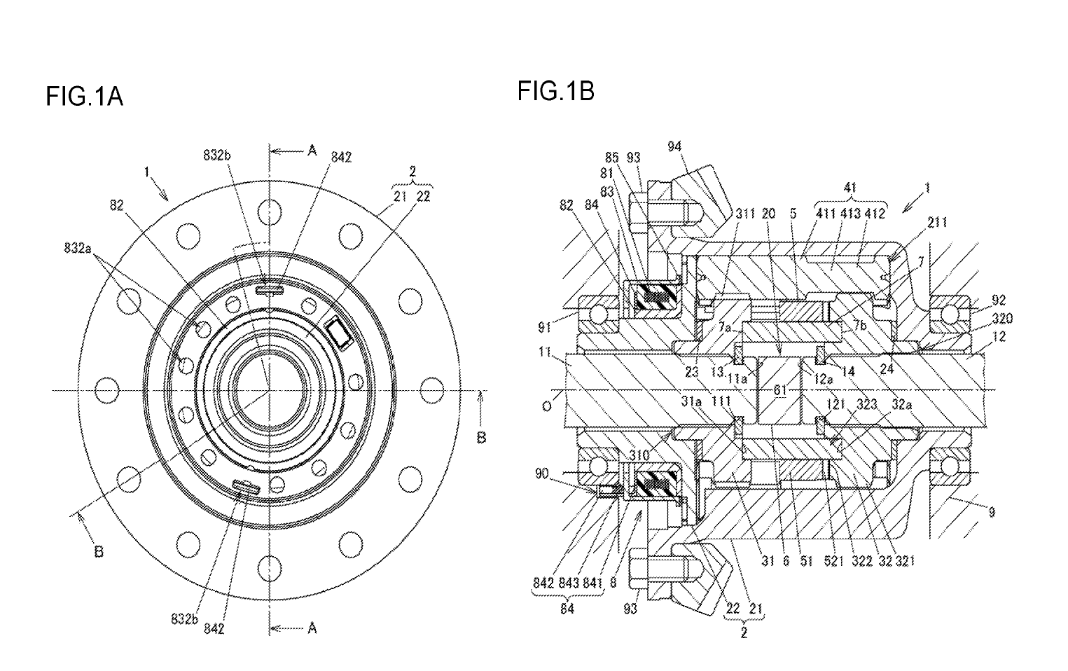

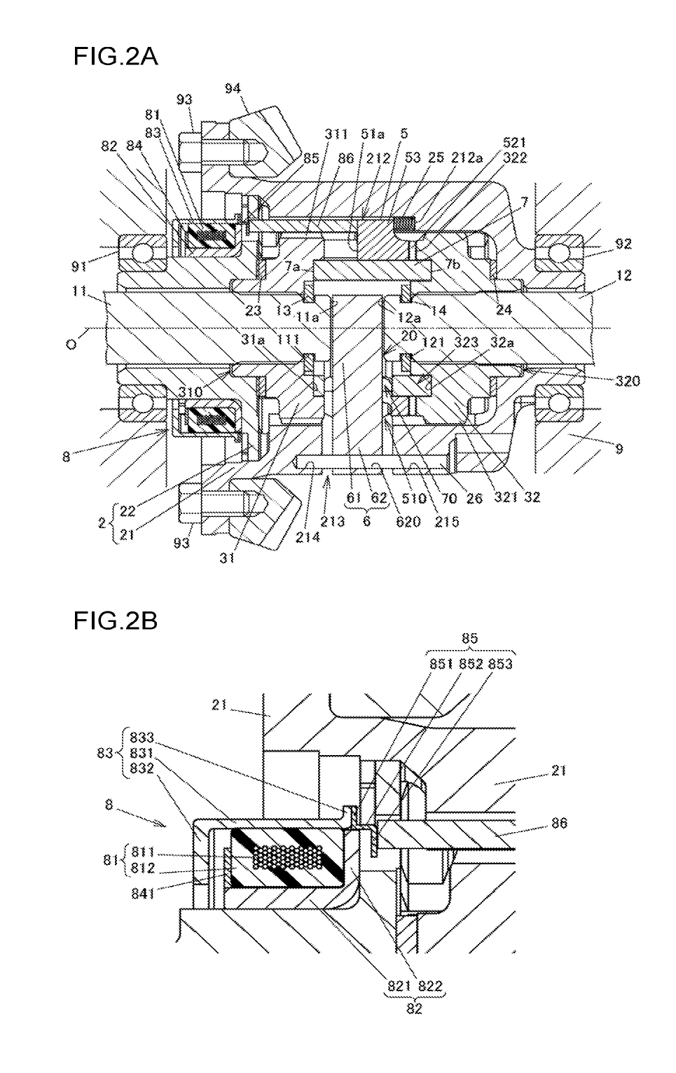

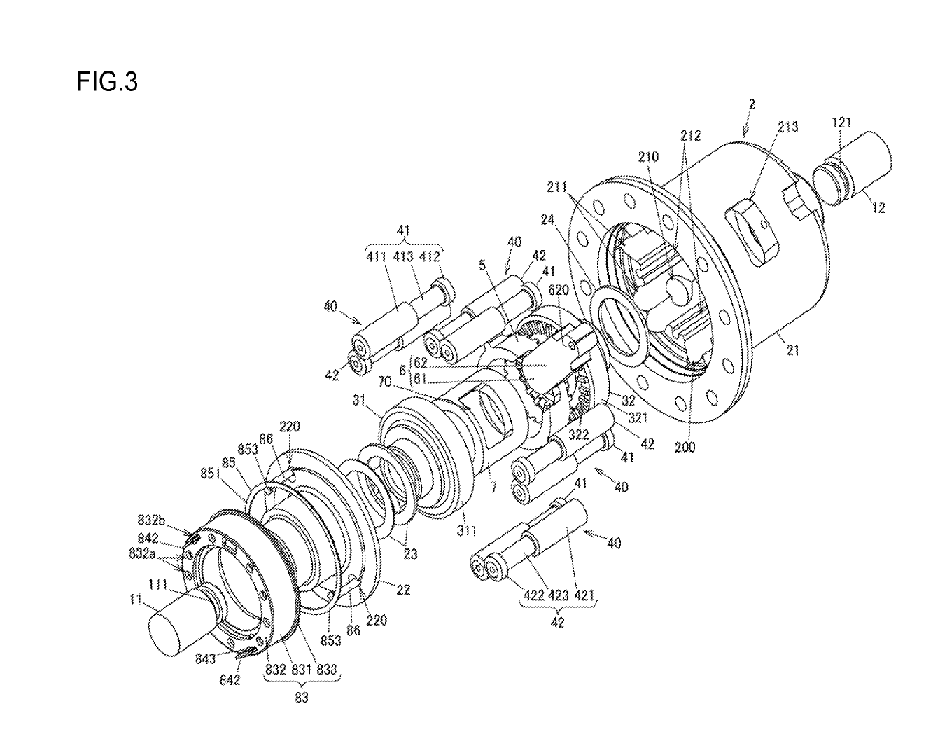

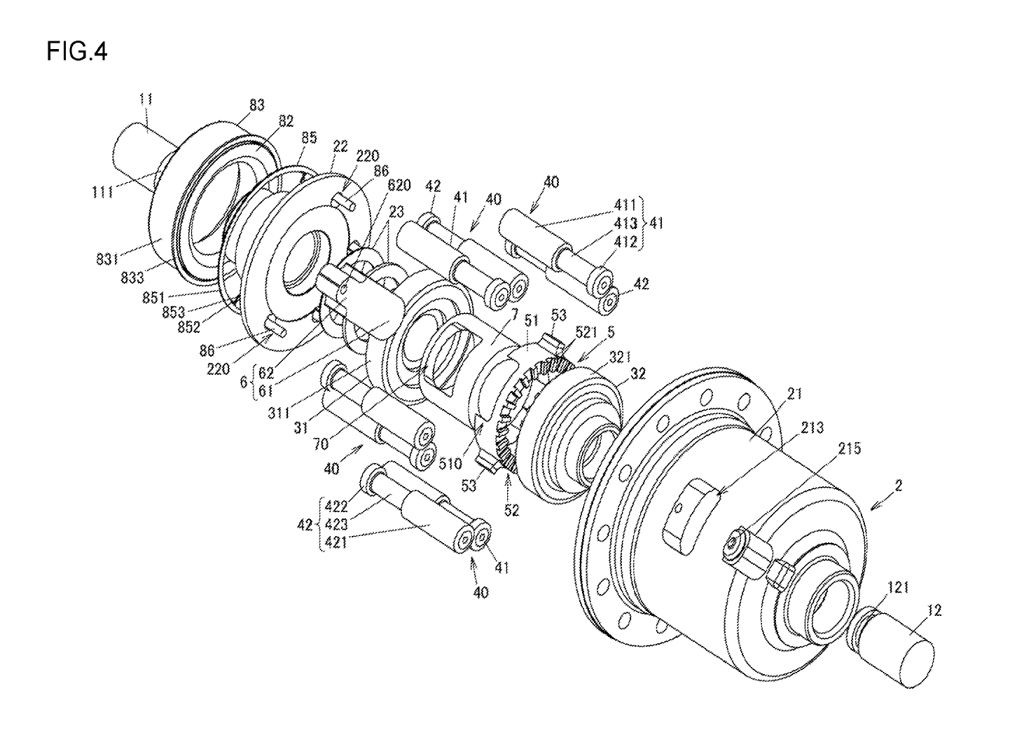

An embodiment of the invention will be described below with reference to FIGS. 1A to 7C. FIG. 1A is an external view of a differential 1 according to an embodiment of the invention, as viewed in the direction of a rotation axis O of a differential case 2. FIG. 1B is a cross-sectional view of the differential 1 according to the embodiment of the invention, taken along the line A-A in FIG. 1A. FIG. 2A is an overall cross-sectional view of the differential 1 taken along the line B-B in FIG. 1A. FIG. 2B is a partially enlarged cross-sectional view of the differential 1 taken along the line B-B in FIG. 1A. FIG. 3 is an exploded perspective view of the differential 1. FIG. 4 is an exploded perspective view of the differential 1 at an angle different from that of FIG. 3.

The differential 1 is used as a vehicle differential to distribute a driving force from a driving source (such as an engine or an electric motor) of a vehicle to right and left driving wheels. The differential 1 has a differential lock function to limit differential rotations of the right and left driving wheels. The differential lock function improves performance of the vehicle to run on rough roads, for example.

The differential 1 includes a first driving shaft 11, a second driving shaft 12, and the differential case 2. The first and second driving shafts 11 and 12 are each coupled to an associated one of the right and left driving wheels of the vehicle. The differential case 2 is a case supported by a differential carrier 9 via a pair of bearings 91 and 92. The differential carrier 9 is secured to a vehicle body. In one example, each of the first and second driving shafts 11 and 12 is a drive shaft whose shaft portions are coupled to each other through constant velocity joint(s). In FIGS. 1B, 2A, 3, and 4, one end of each of the first and second driving shafts 11 and 12 is illustrated. The differential case 2 includes a bottomed cylindrical case body 21 and a case lid 22 that closes an opening defined in the case body 21.

The case body 21 is provided with a plurality of oil holes 210 through which lubricating oil enclosed in the differential carrier 9 flows into and out of the differential case 2. In FIG. 3, one of the oil holes 210 is illustrated. The case lid 22 is secured to the case body 21 by welding or press fitting, for example. The differential case 2 rotates around its rotation axis O upon receiving the driving force from the driving source through a ring gear 94 secured to the case body 21 with a plurality of bolts 93. As used herein, the term “axial” or “axially” refers to a direction parallel to the rotation axis O.

The differential 1 further includes a first side gear 31, a second side gear 32, a plurality of first pinion gears 41, a plurality of second pinion gears 42, an annular clutch ring 5, a spacing member 6, a tubular member 7, a first retaining ring 13, a second retaining ring 14, and a mover 8. The differential 1 restricts rotation of the first side gear 31 relative to the first driving shaft 11. The differential 1 restricts rotation of the second side gear 32 relative to the second driving shaft 12. The first and second pinion gears 41 and 42 transmit the driving force from the differential case 2 to the first and second side gears 31 and 32 while allowing differential rotations of the first and second side gears 31 and 32. The clutch ring 5 serves as a meshing member to mesh with the second side gear 32 so as to restrict rotation of the second side gear 32 relative to the differential case 2. A portion of the spacing member 6 is disposed in an inter-shaft space 20 between an axial end face 11a of the first driving shaft 11 and an axial end face 12a of the second driving shaft 12 so as to maintain a spacing of a predetermined distance or more between the first and second driving shafts 11 and 12. The tubular member 7 maintains an axial spacing between the first side gear 31 and the second side gear 32. The tubular member 7 is provided with an insertion hole 70 through which the spacing member 6 is inserted. The first and second retaining rings 13 and 14 are respectively fitted to the first and second driving shafts 11 and 12. The mover 8 axially moves the clutch ring 5.

The first and second side gears 31 and 32, the first and second pinion gears 41 and 42, the clutch ring 5, the spacing member 6, and the tubular member 7 are housed in the differential case 2 and lubricated with the lubricating oil enclosed in the differential carrier 9. The first and second side gears 31 and 32 are disposed coaxially. The first side gear 31 is disposed adjacent to the opening of the case body 21 (i.e., adjacent to the case lid 22). The second side gear 32 is disposed adjacent to the bottom of the case body 21. A thrust washer 23 is disposed between the first side gear 31 and the case lid 22. A thrust washer 24 is disposed between the second side gear 32 and the bottom of the case body 21.

A central portion of the first side gear 31 is provided with a fitting hole 310 to which the first driving shaft 11 is fitted. A central portion of the second side gear 32 is provided with a fitting hole 320 to which the second driving shaft 12 is fitted. The first side gear 31 and the first driving shaft 11 are relatively non-rotatably spline-fitted to each other. The second side gear 32 and the second driving shaft 12 are relatively non-rotatably spline-fitted to each other.

The first retaining ring 13 is fitted to an end of the first driving shaft 11 closer to the inter-shaft space 20 than the first side gear 31 so as to prevent disconnection of the first driving shaft 11 from the first side gear 31. The second retaining ring 14 is fitted to an end of the second driving shaft 12 closer to the inter-shaft space 20 than the second side gear 32 so as to prevent disconnection of the second driving shaft 12 from the second side gear 32. The first retaining ring 13 is fitted to a peripheral groove 111 defined in the first driving shaft 11. The second retaining ring 14 is fitted to a peripheral groove 121 defined in the second driving shaft 12.

The first pinion gears 41 are in mesh with the second pinion gears 42 so as to provide the pinion gear sets 40. In the present embodiment, the number of pinion gear sets 40 in the differential 1 is five. Four of the pinion gear sets 40 are illustrated in FIGS. 3 and 4. The case body 21 is provided with a plurality of retaining holes 211. The pinion gear sets 40 including the first and second pinion gears 41 and 42 are each rotatably retained in an associated one of the retaining holes 211. The first and second pinion gears 41 and 42 each revolve around the rotation axis O in conjunction with the rotation of the differential case 2. The first and second pinion gears 41 and 42 are each rotatable around its central axis within an associated one of the retaining holes 211.

The first side gear 31 includes an outer peripheral surface provided with a gear wheel 311 including helical teeth. The second side gear 32 includes an outer peripheral surface provided with a gear wheel 321 including helical teeth. The gear wheel 311 and the gear wheel 321 have the same or substantially the same outer diameter. Each first pinion gear 41 integrally includes a long gear wheel 411, a short gear wheel 412, and a coupler 413. The long gear wheel 411 and the short gear wheel 412 each include helical teeth. The long gear wheel 411 and the short gear wheel 412 are axially coupled to each other through the coupler 413. Each second pinion gear 42 integrally includes a long gear wheel 421, a short gear wheel 422, and a coupler 423. The long gear wheel 421 and the short gear wheel 422 each include helical teeth. The long gear wheel 421 and the short gear wheel 422 are axially coupled to each other through the coupler 423.

The long gear wheel 411 of each first pinion gear 41 is in mesh with the gear wheel 311 of the first side gear 31 and the short gear wheel 422 of the associated second pinion gear 42. The short gear wheel 412 of each first pinion gear 41 is in mesh with the long gear wheel 421 of the associated second pinion gear 42. The long gear wheel 421 of each second pinion gear 42 is in mesh with the gear wheel 321 of the second side gear 32 and the short gear wheel 412 of the associated first pinion gear 41. The short gear wheel 422 of each second pinion gear 42 is in mesh with the long gear wheel 411 of the associated first pinion gear 41. In FIGS. 3 and 4, the helical teeth of these gear wheels are not illustrated.

The second side gear 32 is provided with meshing teeth 322 that mesh with meshing teeth 521 of the clutch ring 5. The clutch ring 5 is disposed such that the clutch ring 5 is axially movable and non-rotatable relative to the differential case 2. The mover 8 axially moves the clutch ring 5 between a first position where the clutch ring 5 is out of mesh with the second side gear 32 and a second position where the clutch ring 5 is in mesh with the second side gear 32. Movement of the clutch ring 5 from the first position to the second position causes the meshing teeth 521 of the clutch ring 5 to mesh with the meshing teeth 322 of the second side gear 32. This meshing restricts rotation of the second side gear 32 relative to the differential case 2.

The clutch ring 5 located at the first position allows the first and second side gears 31 and 32 to rotate relative to the differential case 2. The clutch ring 5 located at the second position restricts rotation of the second side gear 32 relative to the differential case 2, so that the first and second pinion gears 41 and 42 are non-rotatable within the retaining holes 211 and the first side gear 31 is non-rotatable relative to the differential case 2. This state will be referred to as a “differential lock state” where the first and second driving shafts 11 and 12 rotate together with the differential case 2.

The mover 8 includes an annular electromagnetic coil 81, a yoke 82, an armature 83, a retainer 84, an annular abutting member 85, and pressers 86. The electromagnetic coil 81 produces magnetic flux upon being energized. The yoke 82 supports the electromagnetic coil 81. The yoke 82 defines a magnetic path for the magnetic flux. The armature 83 is axially moved by a magnetic force from the electromagnetic coil 81. The retainer 84 prevents rotation of the yoke 82 relative to the differential carrier 9. The abutting member 85 abuts against the armature 83 and axially moves together with the armature 83. Each presser 86 receives a moving force from the armature 83 through the abutting member 85 and thus presses the clutch ring 5 so as to axially move the clutch ring 5.

The electromagnetic coil 81 is disposed outside the differential case 2 such that the electromagnetic coil 81 is located axially opposite to the first and second side gears 31 and 32. As illustrated in FIG. 2B, the electromagnetic coil 81 includes a coil 811 and a resin portion 812. The coil 811 is provided by winding a conductor, such as an enameled wire, in a ring. The coil 811 is molded with the resin portion 812 such that the electromagnetic coil 81 is rectangular in cross section. A controller (not illustrated) supplies an exciting current to the coil 811.

The yoke 82 integrally includes an inner cylindrical portion 821 and a side wall 822. The inner cylindrical portion 821 is disposed radially inward of the electromagnetic coil 81. The side wall 822 is protruded radially outward from an axial end of the inner cylindrical portion 821. The inner diameter of the inner cylindrical portion 821 is slightly larger than the outer diameter of an outer peripheral surface of the case lid 22 facing the inner peripheral surface of the inner cylindrical portion 821. This difference in diameter enables the differential case 2 to rotate relative to the yoke 82.

The armature 83 integrally includes an outer cylindrical portion 831, an inner collar 832, and a flange 833. The outer cylindrical portion 831 is disposed radially outward of the electromagnetic coil 81 and the side wall 822 of the yoke 82. The inner collar 832 is protruded radially inward from a first axial end of the outer cylindrical portion 831. The electromagnetic coil 81 is interposed between the inner collar 832 and the side wall 822 of the yoke 82. The flange 833 is protruded radially outward from a second axial end of the outer cylindrical portion 831. The armature 83 receives the magnetic force of the electromagnetic coil 81. This causes the inner peripheral surface of the outer cylindrical portion 831 to slide on the outer peripheral surface of the electromagnetic coil 81, resulting in an axial movement of the armature 83.

As illustrated in FIG. 1B, the retainer 84 integrally includes an annular secured portion 841, arms 842, and locking portions 843. The secured portion 841 is secured to the yoke 82. The arms 842 are axially protruded from peripheral locations on the secured portion 841. Each locking portion 843 is provided by cutting and bending a portion of an associated one of the arms 842. The secured portion 841 is secured to an end of the inner cylindrical portion 821 of the yoke 82 located opposite to the side wall 822 by welding, for example. An extremity of each arm 842 is housed in an associated one of recesses 90 defined in the differential carrier 9. Each arm 842 is thus prevented from rotating relative to the differential carrier 9. In the present embodiment, the number of arms 842 of the retainer 84 is two, and the number of recesses 90 defined in the differential carrier 9 is equal to the number of arms 842. In FIG. 1B, one of the arms 842 and one of the recesses 90 are illustrated.

The inner collar 832 of the armature 83 is provided with a plurality of oil holes 832a and a plurality of insertion holes 832b. The lubricating oil flows through the oil holes 832a. The arms 842 of the retainer 84 are each inserted through an associated one of the insertion holes 832b. Each locking portion 843 of the retainer 84 is disposed closer to the associated recess 90 of the differential carrier 9 than the inner collar 832 of the armature 83. Each locking portion 843 of the retainer 84 thus restricts an axial movement of the armature 83 toward the differential carrier 9 when the electromagnetic coil 81 is not energized.

The abutting member 85 integrally includes an annular plate abutting portion 851, protrusive pieces 852, and tongue pieces 853. The abutting portion 851 abuts against the flange 833 of the armature 83. The protrusive pieces 852 are axially protruded from peripheral locations on the abutting portion 851. Each tongue piece 853 is protruded radially inward from an extremity of an associated one of the protrusive pieces 852. Each presser 86 is located radially outward of the first side gear 31 and has an axially extending columnar shape. A first end of each presser 86 abuts against an associated one of the tongue pieces 853 of the abutting member 85. A second end of each presser 86 abuts against the clutch ring 5. In the present embodiment, the number of pressers 86 of the mover 8 is four, and the number of tongue pieces 853 of the abutting member 85 is four, so that the four pressers 86 are each disposed in association with an associated one of the four tongue pieces 853 of the abutting member 85.

The differential case 2 is provided with a plurality of through holes 220 axially passing through the case lid 22. The pressers 86 are each inserted through an associated one of the through holes 220. During energization of the electromagnetic coil 81, the pressers 86 are axially moved by the magnetic force of the electromagnetic coil 81 so as to press the clutch ring 5. The clutch ring 5 is pressed by the pressers 86 and thus moved from the first position to the second position.

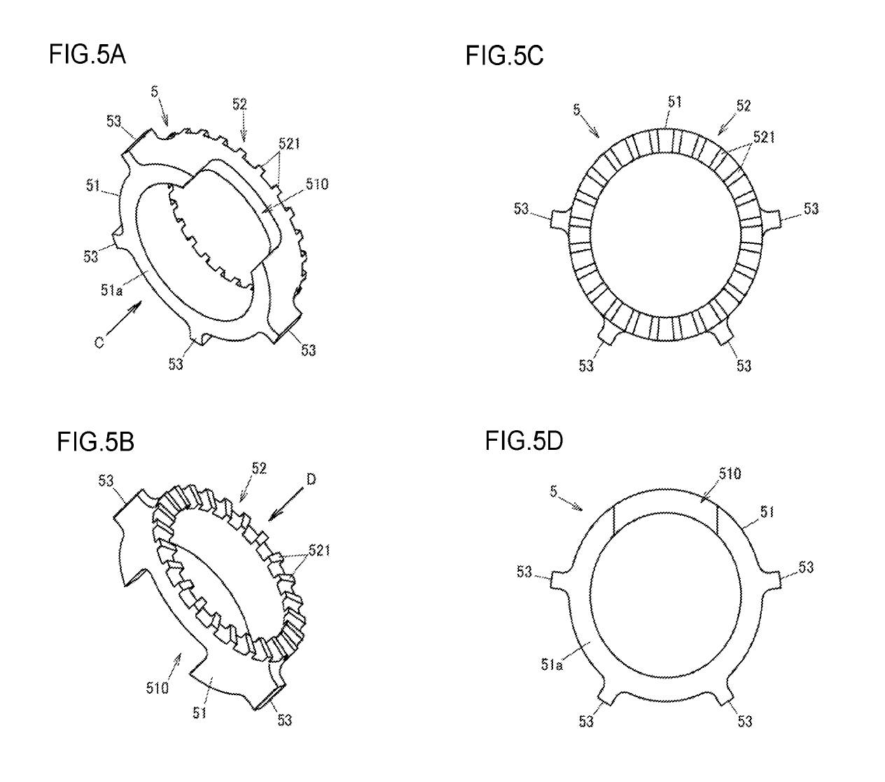

FIG. 5A is a perspective view of the clutch ring 5. FIG. 5B is a perspective view of the clutch ring 5 at an angle different from that of FIG. 5A. FIG. 5C is a diagram illustrating the clutch ring 5, as viewed in the direction indicated by the arrow C in FIG. 5A. FIG. 5D is a diagram illustrating the clutch ring 5, as viewed in the direction indicated by the arrow D in FIG. 5B.

The clutch ring 5 integrally includes a cylindrical body 51, a meshing portion 52, and a plurality of engagement protrusions 53. The meshing portion 52 includes the meshing teeth 521 axially protruding from the body 51. The engagement protrusions 53 are protruded radially outward from the body 51. The body 51 is provided with a cut-out 510 through which the spacing member 6 is inserted. The cut-out 510 is recessed from an end face 51a of the body 51 located opposite to the meshing portion 52 and passes through a portion of the body 51 in its thickness direction (i.e., its radial direction). In the present embodiment, the number of engagement protrusions 53 is four, and the four engagement protrusions 53 are extended radially from the body 51 except a portion of the body 51 where the cut-out 510 is defined.

The case body 21 is provided with axially extending engagement grooves 212 in engagement with the engagement protrusions 53 of the clutch ring 5. In the present embodiment, the number of engagement grooves 212 is five, and the five engagement grooves 212 extend in parallel with each other in the axial direction of the case body 21. Each engagement groove 212 extends from an end face of the case body 21 adjacent to the case lid 22 toward the bottom of the case body 21. The engagement protrusions 53 of the clutch ring 5 are each in engagement with an associated one of the engagement grooves 212. The clutch ring 5 is thus axially movable and non-rotatable relative to the differential case 2.

The clutch ring 5 is disposed between the first side gear 31 and the second side gear 32 in the axial direction of the differential 1. The end face 51a of the body 51 of the clutch ring 5 provided with the cut-out 510 axially faces the first side gear 31. With the clutch ring 5 located at the first position, the axial spacing between the clutch ring 5 and the first side gear 31 is small. Movement of the clutch ring 5 to the second position increases the axial spacing between the clutch ring 5 and the first side gear 31.

The case body 21 houses an urging member that urges the clutch ring 5 to the first position. In the present embodiment, the urging member includes a plurality of coil springs 25. The coil springs 25 are each disposed in association with a corresponding one of the engagement protrusions 53 of the clutch ring 5 such that each coil spring 25 is axially compressed at the terminating end of an associated one of the engagement grooves 212. A first axial end of each coil spring 25 is in abutment with a terminating end face 212a of an associated one of the engagement grooves 212. A second axial end of each coil spring 25 is in abutment with an associated one of the engagement protrusions 53 of the clutch ring 5. When the supply of the exciting current to the electromagnetic coil 81 is stopped, the urging force of each coil spring 25 moves the clutch ring 5 to the first position.

An axial portion of each presser 86 is housed in an associated one of the engagement grooves 212 and is in abutment with an associated one of the engagement protrusions 53 of the clutch ring 5. The engagement protrusions 53 of the clutch ring 5 are each interposed between the associated presser 86 and the associated coil spring 25 in the axial direction of the differential 1. The clutch ring 5 thus receives a pressing force from each presser 86 of the mover 8 and the urging force of each coil spring 25.

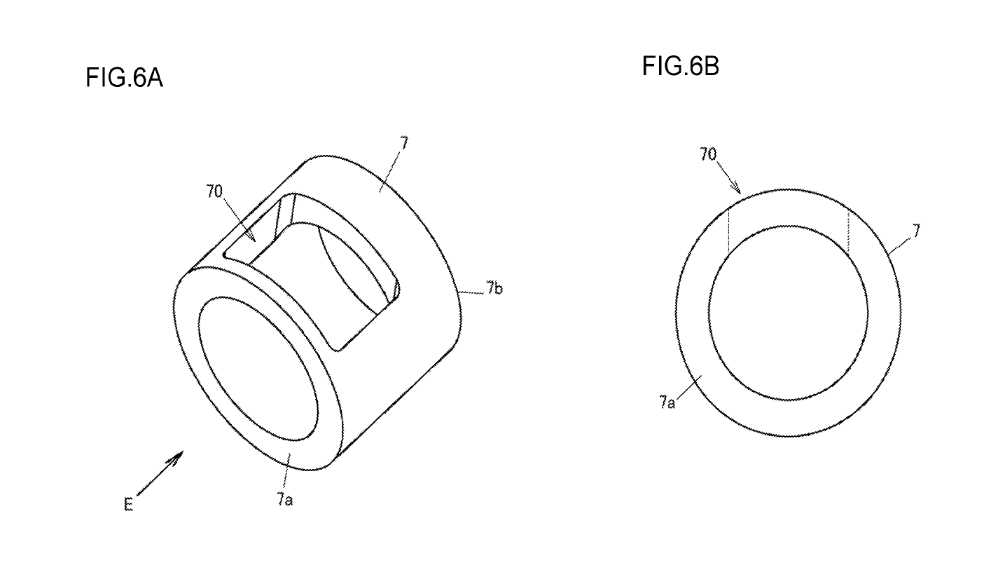

FIG. 6A is a perspective view of the tubular member 7. FIG. 6B is a diagram illustrating the tubular member 7, as viewed in the direction indicated by the arrow E in FIG. 6A. The tubular member 7 has a cylindrical shape. The tubular member 7 includes a first axial end face 7a and a second axial end face 7b. The first axial end face 7a faces an axial end face 31a of the first side gear 31. The second axial end face 7b faces an axial end face 32a of the second side gear 32. The second side gear 32 is provided with an annular fitting groove 323 extended circumferentially and recessed axially. The axial end face 32a is the bottom surface of the fitting groove 323.

An end of the tubular member 7 located adjacent to the second side gear 32 is fitted to the fitting groove 323. This restricts a radial movement of the tubular member 7 relative to the second side gear 32. The tubular member 7 functions as a spacer to maintain an axial spacing between the first side gear 31 and the second side gear 32. The tubular member 7 thus restricts an axial movement of the first side gear 31 toward the second side gear 32 and an axial movement of the second side gear 32 toward the first side gear 31.

The clutch ring 5 is disposed radially outward of the tubular member 7. In other words, the tubular member 7 is disposed inward of the body 51 of the clutch ring 5. The outer diameter of the tubular member 7 is slightly smaller than the inner diameter of the body 51 of the clutch ring 5.

The spacing member 6 integrally includes a head 61 and a body 62. The head 61 is inserted into the differential case 2 through an insertion hole 213 defined in the case body 21. The body 62 is disposed in the insertion hole 213. The head 61 is disposed in the inter-shaft space 20 between the axial end face 11 a of the first driving shaft 11 and the axial end face 12a of the second driving shaft 12. The head 61 thus functions as a spacer to maintain a spacing of a predetermined distance or more between the first driving shaft 11 and the second driving shaft 12. An end of the body 62 located opposite to the head 61 is provided with an insertion hole 620. A shaft member 26 having a columnar shape is inserted through the insertion hole 620. The insertion hole 620 passes through the body 62 in the axial direction of the differential 1.

The shaft member 26 is inserted through the insertion hole 620 of the body 62 and inserted into a pair of axial holes 214 and 215 defined in the case body 21. The shaft member 26 is thus secured to the case body 21. The insertion hole 213 is defined between the axial holes 214 and 215. In the present embodiment, the shaft member 26 is press-fitted into the axial holes 214 and 215 and thus secured to the case body 21. The shaft member 26 may be secured to the case body 21 in any other manner. In one example, the shaft member 26 may be screwed to the case body 21. In another example, the shaft member 26 may be welded to the case body 21. The inner diameter of the insertion hole 620 of the body 62 is slightly larger than the outer diameter of the shaft member 26. The spacing member 6 is thus axially movable while being guided by the shaft member 26.

The spacing member 6 is inserted through the cut-out 510 of the clutch ring 5 and the insertion hole 70 of the tubular member 7. The spacing member 6 is inserted into the differential case 2, with the insertion hole 213 of the case body 21, the cut-out 510 of the clutch ring 5, and the insertion hole 70 of the tubular member 7 aligned in a radial direction perpendicular to the rotation axis O. After the insertion of the spacing member 6 into the differential case 2, the shaft member 26 is inserted through the insertion hole 620 of the body 62 and inserted into the axial holes 214 and 215.

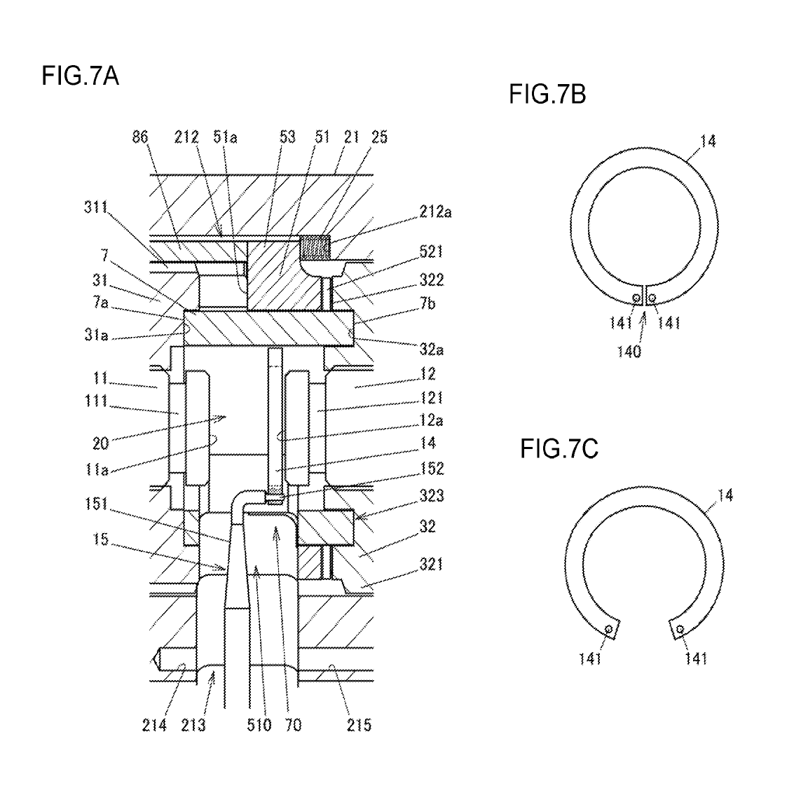

Before the insertion of the spacing member 6 into the differential case 2, the first and second retaining rings 13 and 14 are respectively fittable to the first and second driving shafts 11 and 12 through the insertion hole 213 of the case body 21 and the inter-shaft space 20. The step of fitting the first retaining ring 13 to the first driving shaft 11 and fitting the second retaining ring 14 to the second driving shaft 12 will be described with reference to FIGS. 7A to 7C.

FIG. 7A is a schematic diagram illustrating the step of fitting the second retaining ring 14 to the second driving shaft 12. FIG. 7B is a plan view of the second retaining ring 14 in a natural state. FIG. 7C is a plan view of the second retaining ring 14 increased in diameter. The first retaining ring 13 is similar in shape to the second retaining ring 14. The first retaining ring 13 is fitted to the first driving shaft 11 in a manner similar to that in which the second retaining ring 14 is fitted to the second driving shaft 12.

Each of the first and second retaining rings 13 and 14 is an elastically deformable C-shaped snap ring. Using angle type snap ring pliers 15 including a pair of bent arms 151, the first and second retaining rings 13 and 14 are respectively fitted to the first and second driving shafts 11 and 12. As illustrated in FIGS. 7B and 7C, ends of the second retaining ring 14 between which a slit 140 is defined are each provided with a through hole 141. The second retaining ring 14 is elastically increased in diameter by the snap ring pliers 15.

The arms 151 of the snap ring pliers 15 are pivotable around a pivot (not illustrated). An extremity of each arm 151 is provided with a small-diameter shaft protrusion 152. In FIG. 7A, one of the arms 151 is illustrated.

When the second retaining ring 14 is fitted to the second driving shaft 12, the second retaining ring 14 is inserted into the differential case 2 together with the arms 151, with the protrusions 152 of the snap ring pliers 15 fitted through the through holes 141 of the second retaining ring 14 in advance. In this step, the second retaining ring 14 passes through the insertion hole 213 of the case body 21, the cut-out 510 of the clutch ring 5, and the insertion hole 70 of the tubular member 7 and then enters the inter-shaft space 20 between the axial end face 11 a of the first driving shaft 11 and the axial end face 12a of the second driving shaft 12. FIG. 7A illustrates a state where the second retaining ring 14 has entered the inter-shaft space 20.

As illustrated in FIG. 7C, the second retaining ring 14 is then increased in diameter, and the second retaining ring 14 is moved to a position where the second retaining ring 14 is located outward of the peripheral groove 121 of the second driving shaft 12. Subsequently, the arms 151 of the snap ring pliers 15 are closed so as to fit the second retaining ring 14 to the peripheral groove 121 of the second driving shaft 12. This completes assembly of the second retaining ring 14 to the second driving shaft 12. The first retaining ring 13 is assembled to the first driving shaft 11 in a manner similar to that just described. The first retaining ring 13 may be assembled to the first driving shaft 11 before the second retaining ring 14 is assembled to the second driving shaft 12, or the second retaining ring 14 may be assembled to the second driving shaft 12 before the first retaining ring 13 is assembled to the first driving shaft 11.

After the first and second retaining rings 13 and 14 are respectively assembled to the first and second driving shafts 11 and 12, the spacing member 6 is inserted into the differential case 2 in the order of the head 61 and then the body 62, and the shaft member 26 is inserted through the insertion hole 620 of the body 62 to restrict disconnection of the body 62 from the differential case 2.

The embodiment described above involves disposing the clutch ring 5 between the first side gear 31 and the second side gear 32. This makes it possible to maintain a spacing of a predetermined distance or more between the first driving shaft 11 and the second driving shaft 12 by the spacing member 6 and restrain an increase in size of the differential 1. Because the annular clutch ring 5 is disposed radially outward of the inter-shaft space 20 in which the head 61 of the spacing member 6 is disposed, the configuration according to the present embodiment increases the space efficiency of the differential 1 and restrains an increase in the axial length of the differential 1.

In the present embodiment, the first and second retaining rings 13 and 14 are respectively fittable to the first and second driving shafts 11 and 12 through the insertion hole 213 of the case body 21 and the inter-shaft space 20. The space through which the spacing member 6 is inserted into the differential case 2 and the space in which the spacing member 6 is disposed are thus effectively utilized to respectively fit the first and second retaining rings 13 and 14 to the first and second driving shafts 11 and 12. This facilitates the fitting of the first and second retaining rings 13 and 14 to the first and second driving shafts 11 and 12. Accordingly, an increase in the size of the differential 1 is restrained more effectively than when a space for the assembly of the first and second retaining rings 13 and 14 to the first and second driving shafts 11 and 12 is additionally provided.

In the present embodiment, the pressers 86 of the mover 8 are located radially outward of the first side gear 31 and extended axially. This makes it possible to press and move the clutch ring 5 disposed between the first side gear 31 and the second side gear 32, although the electromagnetic coil 81 and the yoke 82 are disposed outside the differential case 2.

In the present embodiment, the tubular member 7 maintains a spacing between the first side gear 31 and the second side gear 32, and the clutch ring 5 is disposed radially outward of the tubular member 7. The tubular member 7 thus radially overlaps with the clutch ring 5 so as to restrain an increase in the size of the differential 1.

The invention may be modified as appropriate without departing from the spirit of the invention. Although the foregoing embodiment has been described on the assumption that the differential 1 distributes the driving force to the right and left driving wheels of the vehicle. Alternatively, the invention may be applied to a center differential to distribute a driving force to front and rear wheels of a four-wheel drive vehicle. In this case, first and second driving shafts of the vehicle are front and rear propeller shafts.

What is claimed is:

1. A differential comprising:
a first driving shaft;
a second driving shaft;
a first side gear whose rotation relative to the first driving shaft is restricted;
a second side gear whose rotation relative to the second driving shaft is restricted, the second side gear being disposed coaxially with the first side gear;
a case housing the first and second side gears, the case being configured to be rotated by a driving force from a driving source of a vehicle;
a plurality of pinion gears configured to revolve around a rotation axis of the case in conjunction with the rotation of the case and transmit the driving force from the case to the first and second side gears while allowing differential rotations of the first and second side gears;
a spacing member disposed into the case through an insertion hole of the case, the spacing member being partially disposed in an inter-shaft space between an axial end face of the first driving shaft and an axial end face of the second driving shaft so as to maintain a spacing of a predetermined distance or more between the first and second driving shafts;
a meshing member disposed such that the meshing member is movable relative to the case in an axial direction and non-rotatable relative to the case, the axial direction being parallel to the rotation axis, the meshing member being configured to mesh with the second side gear so as to restrict rotation of the second side gear relative to the case; and
a mover configured to move the meshing member in the axial direction between a first position where the meshing member is out of mesh with the second side gear and a second position where the meshing member is in mesh with the second side gear, wherein
the meshing member is disposed between the first side gear and the second side gear.

2. The differential according to claim 1, further comprising:
a first retaining ring fitted to the first driving shaft so as to restrict disconnection of the first driving shaft from the first side gear; and
a second retaining ring fitted to the second driving shaft so as to restrict disconnection of the second driving shaft from the second side gear, wherein
the first and second retaining rings are respectively fittable to the first and second driving shafts through the insertion hole of the case and the inter-shaft space.

3. The differential according to claim 1, wherein
the mover includes
an electromagnetic coil disposed adjacent to a portion of the first side gear located opposite to the second side gear in the axial direction, and
a presser configured to be moved in the axial direction by a magnetic force of the electromagnetic coil,
the presser is located radially outward of the first side gear and extended in the axial direction, and
the meshing member is moved from the first position to the second position by being pressed by the presser.

4. The differential according to claim 1, further comprising a tubular member housed in the case, the tubular member maintaining a spacing between the first side gear and the second side gear in the axial direction, the tubular member being provided with an insertion hole through which the spacing member is disposed, wherein
the meshing member is disposed radially outward of the tubular member.
